(19) United States
(12) Patent Application Publication
(10) Pub. No.: US 2015/0195482 A1
(43) Pub. Date: Jul. 9, 2015

(54) METHOD, SYSTEM AND SMARTPHONE THAT CHOOSES OPTIMAL IMAGE TO REDUCE SHUTTER SHAKE

(71) Applicant: Nvidia Corporation, Santa Clara, CA (US)

(72) Inventor: Joshua Wise, Santa Clara, CA (US)

(73) Assignee: Nvidia Corporation, Santa Clara, CA (US)

(21) Appl. No.: 14/150,267

(22) Filed: Jan. 8, 2014

(51) Int. Cl. H04N 5/77; H04N 5/225; H04M 1/02

(52) U.S. Cl. CPC H04N 5/772; H04M 1/0264; H04N 5/2252

(57) ABSTRACT

An image capturer for reducing the effect of shutter shake of a digital camera in a smartphone, a method of capturing an image employing a digital camera, and a smartphone. In one embodiment, the image capturer includes: (1) a control interface configured to receive a command to photograph a scene and (2) a best shot determiner, coupled to the control interface and configured to select, after a focused image of the scene has been acquired and in response to receiving the command, a captured image of the scene based on sharpness metrics.

### TECHNICAL FIELD

This application is directed, in general, to image signal processing and, more specifically, to reducing the effect of shutter shake when using the digital cameras of smartphones.

### BACKGROUND

Digital photography has become commonplace. Whether the photography is done with a dedicated still camera, a videocamera, or a smartphone having a camera or video function, the high-level procedure is the same. Optics are employed to focus an image of a scene being photographed on a sensor. On command, the sensor captures the image as an array of picture elements, or pixels. The pixels are transferred over a bus to a processor and eventually gets written to memory. Additional images may then be captured using the array.

As consumers are aware, today's cameras and smartphones are offering ever-increasing image resolution that require processing power and tax the bandwidth of the bus that is responsible for moving the images to the memory.

Additionally, compounding these demands are less-apparent advances in image processing in which multiple images are captured in rapid succession, processed and reassembled to allow images to be taken under low-light conditions, increase image depth-of-field, allow the image plane to be changed after-the-fact or reduce the blurring, often called “shutter shake,” that results from camera movement when using the shutter. For example, when a user takes a photograph with a phone-shaped device like a smartphone, the user typically holds the smartphone with one hand, views a scene through a display and hits the shutter forward-on with the other hand. This operation can create a lot of shake in a still photograph in what appeared to be a stable preview on the display screen of the smartphone.

### SUMMARY

In one aspect, the disclosure provides an image capturer for reducing the effect of shutter shake of a digital camera in a smartphone. In one embodiment, the image capturer includes: (1) a control interface configured to receive a command to photograph a scene and (2) a best shot determiner, coupled to the control interface and configured to select, after a focused image of the scene has been acquired and in response to receiving the command, a captured image of the scene based on sharpness metrics.

In another aspect, the disclosure provides a method of capturing an image employing a digital camera. In one embodiment, the method includes: (1) generating sharpness metrics for raw images of a scene, (2) obtaining a focused image of the scene from the raw images employing the sharpness metrics, (3) receiving a command to photograph the scene employing the digital camera and (4) selecting, after the obtaining and the receiving, a captured image of the scene based on the sharpness metrics.

In yet another aspect, the disclosure provides a smartphone. In one embodiment, the smartphone includes: (1) a lens for viewing a scene, (2) a shutter configured to activate a capture command to photograph the scene, (3) a photodetector configured to acquire multiple raw images of the scene and (4) an image signal processor having: (4A) a focus metric module configured to generate focus metrics for the raw images that are employed by the lens to obtain a focused image of the scene from the raw images and (4B) an image capturer for reducing the effect of shutter shake when employing the shutter, the image capturer having a best shot determiner configured to select, after the focused image has been obtained, a captured image of the scene from a buffer of the raw images based on the focus metrics and in response to the capture command.

### BRIEF DESCRIPTION

Reference is now made to the following descriptions taken in conjunction with the accompanying drawings, in which:

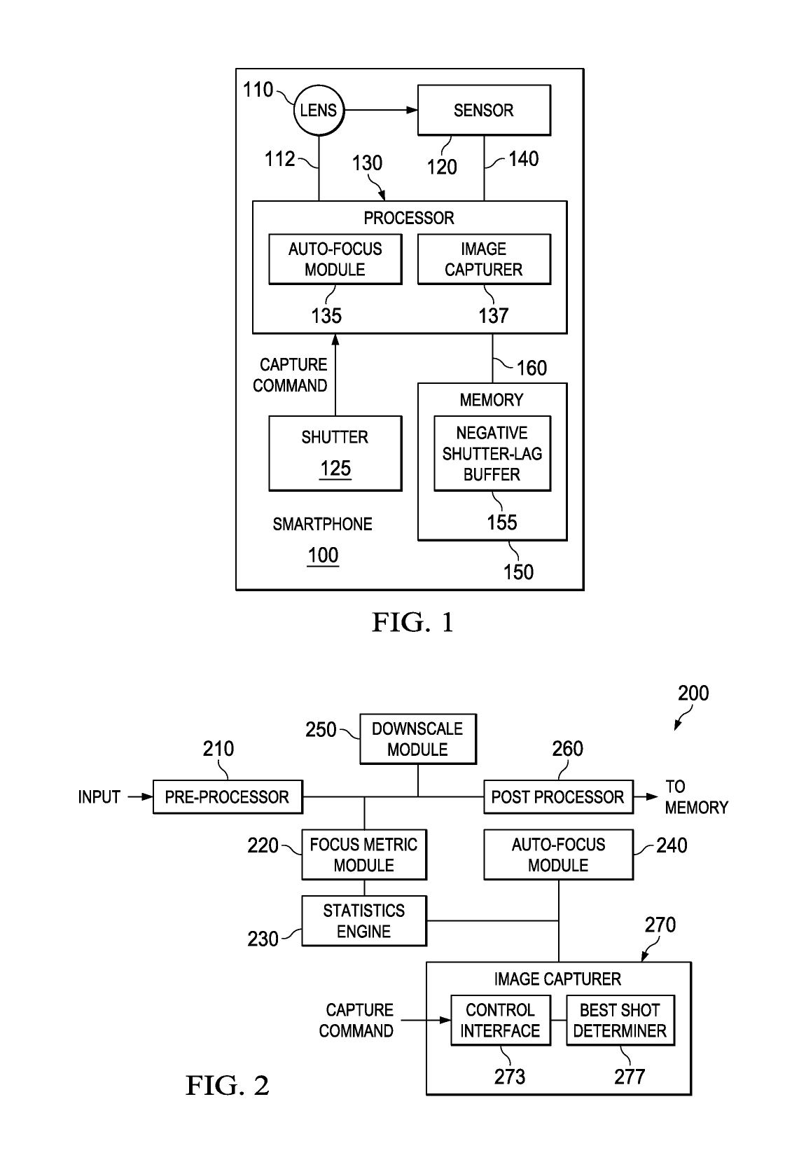

FIG. 1 is a high-level block diagram of one embodiment of a smartphone having a camera or video function and constructed according to the principles of the disclosure;

FIG. 2 is a block diagram of an embodiment of an image processing pipeline having an image capturer constructed according to the principles of the disclosure; and

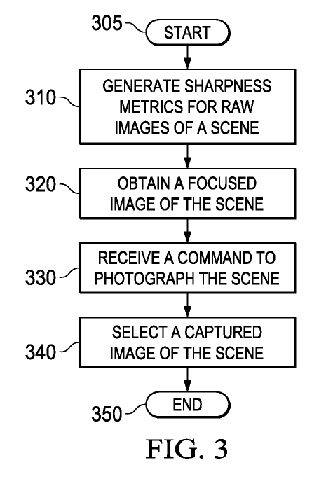

FIG. 3 is a flow diagram of one embodiment of a method of capturing an image employing a digital camera.

### DETAILED DESCRIPTION

As stated above, some cameras and smartphones have been able to address shutter shake through image processing. One example includes using a buffer to store images of a scene and pick an image of a static duration back in time (i.e., a static image) from the buffer for a photograph before, in theory, any shake would have occurred. The buffer is sometimes referred to as a “negative shutter lag buffer” and can store a history of images from a scene for a designated amount of time, such as for the last 0.5 second. It is realized herein that selecting a stale image from the past does not necessarily correspond to the present scene for which a photograph is desired. Instead, the selected image can represent a different view of the scene due to changes in lighting, movement of people, etc., and not be the sharpest image. Thus, selecting from stale images lacks the precision necessary to accurately reflect a desired photograph of a scene.

Other processing methods can be employed that provide a more accurate representation than selection from stale images in a buffer. Deconvolution is another example of image processing that may be used to address shutter shake. This process, however, generally provides poor image quality and is computationally intensive. Still another image processing option for shutter shake sends all of the images in preview mode through image processing at full resolution to determine the best image for the photograph. This full resolution image processing (full processing), however, runs the images through a JPEG encoder which requires bandwidth and power.

It is realized herein that digital cameras and smartphones are remote devices with a battery power source that is drained by the intensive computations and power requirements of the conventional processing options used to address shutter shake. It is further realized herein that the battery power source can be conserved if existing hardware or function modules normally employed in image processing pipeline can also be used or reused to address shutter shake. Accordingly, the disclosure provides a system and method that employs existing sharpness metrics to select a raw image of a scene as a captured image for the photograph of the scene. Existing sharpness metrics, referred to hereafter as sharpness metrics, are metrics that are already being used for another function of an image signal processor or in an image processing pipeline to identify or obtain a focused image, i.e., a sharp image, of a scene to be photographed. A captured image as used herein is the optimal raw image that is selected for the photograph of the scene. In one embodiment, the optimal raw image is a sharp image with minimum or no blurriness. In some embodiments, the optimal image is an image with the least amount of blurriness among multiple images. In other embodiments, the optimal raw image selected is based on the sharpness and the recency. In one embodiment, the recency is the time difference between obtaining the raw images and activation of the shutter.

A focus metric is an example of a sharpness metric that can be employed. A focus metric is a statistic that provides a measurement indicating the sharpness of an image and is employed by image signal processors for autofocusing. In some embodiments, the sharpness or quality of an image can be advantageously determined by the focus metric of the raw image. A focus metric module is typically employed to generate a focus metric. In addition to a focus metric, in some embodiments a low cost filter can be added to generate a sharpness metric from the results or measurements of other pixel processing that occurs through a GPU.

The disclosed system and method employ the sharpness metric to dynamically select a captured image for a photograph of a desired scene instead of selecting a stale image from a buffer that may not be the sharpest image. Thus, embodiments of an improved system and method are disclosed herein that allows choosing an optimal frame or image that accurately portrays a scene to be photographed that prevents or at least reduces shutter shake without the power, bandwidth and computational requirements of existing image processes. The disclosed embodiments minimize shutter shake by advantageously employing sharpness metrics that are already being used for auto-focusing or other standard functions of an image signal processor or image signal processing pipeline.

FIG. 1 is a high-level block diagram of one embodiment of a smartphone 100 having a camera or video function. As those skilled in the pertinent art understand, a smartphone is generally characterized as having a prominent display screen (not shown) and providing an application programming interface (API) to an operating system (OS) allowing third-party software applications, typically called “apps,” to execute in the smartphone. Examples of current smartphones use the Android, iOs®, Windows® Phone, BlackBerry® or Bada®, Symbian®, Palm OS®, Windows® Mobile OS.

The smartphone has a lens 110 operable for viewing a scene to be photographed and to focus an image of the scene on a sensor 120. The lens 110 is a moveable lens that can be focused via an auto-focus module 135 described below. The sensor 120, typically a rectangular photodetector array, is configured to continuously acquire an image or images of the scene as an array of pixels, i.e., a raw image before image processing, such as demosaicing in an image processing pipeline of the smartphone 100. As those skilled in the pertinent art understand, the sensor 120, which may be, for example, metal oxide semiconductor (MOS) charge-coupled devices (CCDs) or complementary semiconductor (CMOS) photosensors, produce analog signals that are quantized to a particular precision. The acquired raw images are stored in a negative shutter lag buffer 155. Accordingly, the raw images are transferred from the sensor 120 over a bus 140 to a processor 130 and to the negative shutter lag buffer 155, located in a memory 150, via a bus 160. Activation of a shutter 125 initiates selection of a raw image or images of the scene from the negative shutter lag buffer 155 for a photograph. Accordingly, the processor 130 directs the selected raw image to be transferred via the buffer 160 to the processor 130 from the negative shutter lag buffer 155 for processing.

The processor 130 can be an image signal processor. In one embodiment, the sensor 120 can include image signal processing. In some embodiments, the processor 130 is a computational photography engine that is configured to receive images from the sensor 120 and process the images for storing. The computational photography engine includes an image signal processor with a central processing unit and a graphics processing unit. The processor 130 directs the processed image to be transferred therefrom to the memory 150 over the bus 160.

The processor 130 includes an auto-focus module 135 that is configured to control focusing of the lens 110 via a control connection 112. The auto-focus module 135 employs a focus metric for focusing the lens 110. The focus metric module is a conventional statistics module employed by a statistic engine of an image processing pipeline. The lens 110, control connection 112, sensor 120, shutter 125, buses 140, 160, and the auto-focus module 135 can all be conventional components of a smartphone.

As noted above, when the shutter 125 is activated, such as being depressed or touched, selection of a raw image from the negative shutter lag buffer 155 is initiated by the processor 130. In one embodiment, activation of the shutter 125 causes multiple raw images to be selected. The negative shutter lag buffer 155 provides a history of images for the scene. The buffer is typically a circular buffer.

Considering a conventional smartphone, obtaining a photograph includes the following transactions to memory 150 for every frame that is captured. (1) A raw frame is transferred from the sensor 120 to memory 150 (i.e., the negative shutter lag buffer 155). (2) A raw frame is then selected from the negative shutter lag buffer 155 for processing by the processor 130. (3) The processed frame is then transferred from the processor 130 to the memory 150. (4) For display, a downscaled frame is also transferred from the processor 130 to the memory 150. (5) A processed frame is transferred from the memory 150 to a JPEG encoder (not illustrated) and (6) after additional processing transferred to the memory 150 for storage. If processing each of the raw images through the JPEG encoder can be avoided, then the above noted steps 3, 5, and 6 can be eliminated for most frames and used only for the frames that are actually desired to be saved. This can save memory bandwidth and power.

Accordingly, in contrast to a conventional smartphone, the processor 130 also includes an image capturer 137 that is configured to employ sharpness metrics, such as the focus metrics, to reduce shutter shake when the shutter 125 is used. The image capturer 137 is configured to select a captured image for the scene from the raw images of the buffer based on the sharpness metrics associated with the raw images and in response to receiving the capture command initiated by the shutter 125. Thus in one embodiment and in contrast to some conventional image processing pipelines, an image from the past is not selected as the captured image. Instead, the image capturer 137 dynamically selects a captured image employing the best focus metric result or optimal focus metric result. Thus, a captured image is selected after a focused image is obtained and after receiving the capture command.

As noted above the processor 130 can be an image signal processor. An image signal processor is configured to receive images from a sensor, such as sensor 120, and process the images for storing or viewing. Image signal processors employ image processing pipeline for processing the images, still or video images. FIG. 2 illustrates an image processing pipeline that can be employed in the processor 130.

FIG. 2 is a block diagram of an embodiment of an image processing pipeline 200 having an image capturer constructed according to the principles of the disclosure. The image processing pipeline 200 can be employed in an image signal processor. The image processing pipeline 200 receives raw images from a buffer for processing. The raw images can be stored in a negative shutter lag buffer such as the one disclosed in FIG. 1.

The image processing pipeline 200 includes a pre-processor 210, a focus metric module 220, a statistics engine 230, an auto-focus module 240, a downscale module 250, a post-processor 260 and an image capturer 270. Pre-processing, such as color space corrections and gamma corrections, include conventional corrections that are employed by the auto-algorithms of the image processing pipeline 200. The auto-algorithms are auto-exposure, auto-white balance and auto-focus algorithms. The auto-focus algorithm is represented by the auto-focus module 240. The auto-algorithms or modules are basic functions employed in the pipelines. The auto-algorithms can be implemented by software.

The auto-focus module 240 is configured to employ a focus metric to automatically focus an image of a scene on a sensor. The focus metric is provided by the focus metric module 220. The focus metric module 220 is a statistics collection block, such as a local average block or a histogram block, of the image processing pipeline 200. The output of the focus metric module 220, the focus metric, is provided to the statistics engine 230 that stores collected statistics to be used for processing images on the image processing pipeline 200. For example, as noted above, the auto-focus module 240 employs the focus metric for auto-focusing.

The focus metric module 220 receives an image and is configured to provide a sharpness metric or data point for the image based on how well the image is focused; i.e., a data point that represents sharpness. In one embodiment, the focus metric module 220 performs a convolution operation and based thereon generates a power measurement that is the focus metric for auto-focusing. In one embodiment, the focus metric module 220 is a modified power measurement after a high-pass filter. The “least blurry” image as reflected by the focus metrics of the images, is also most likely to be the optimal image with the least amount of shutter shake. A least blurry image of multiple images would have the highest focus metric thereof.

The downscale module 250 is used to process an image for viewing on a display screen of the device, i.e., on-device viewfinder mode. The post-processor 260 is configured to provide full resolution processing for images. Post-processing can include demosaicing. After post-processing, processed images can be sent to a memory for storing.

Each of the above noted components of the image processing pipeline 200 can be a conventional component of image processing pipeline typically employed with a smartphone or a digital camera. One skilled in the art will understand that the image processing pipeline 200 can include other processing blocks or modules that are typically included within such an image processing pipeline. In addition the image processing pipeline 200 includes the image capturer 270. The image capturer 270 is configured to reduce shutter shake by advantageously employing the focus metric. As noted above, in other embodiments, the image capturer 270 can employ other sharpness metrics to reduce shutter shake.

The image capturer 270 includes a control interface 273 and a best shot determiner 277. The control interface 273 is configured to receive the capture command or notice thereof that initiates photographing a scene. The best shot determiner 277 is configured to select, after a focused image of the scene has been acquired by the auto-focus module 240 and in response to receiving the capture command, a captured image of the scene based on focus metrics. In one embodiment, the best shot determiner 277 is configured to select the captured image from a buffer of raw images, such as a negative shutter lag buffer. In some embodiments, the best shot determiner 277 can sort the raw images in the buffer based on quality and recency. The recency can be based on the capture command and when the raw images were obtained. For example, the buffer can include a half-second history of raw images. The best shot determiner 277 examines the collection of raw images obtained within a designated time of receiving the capture command and sorts them based on their quality. The designated time may be ⅛ of a second and the quality is based on the focus metric of the raw images. Thus, instead of selecting the least blurriest image of a buffer, a more recent image that is slightly blurrier can be selected over a blurrier image that is later in time.

The best shot determiner 277 is configured to select the captured image before full processing of the captured image. Thus, power consuming processing can is prevented by using the focus metric of the raw images as a measurement for shutter shake.

FIG. 3 is a flow diagram of one embodiment of a method 300 of capturing an image employing a digital camera carried out according to the principles of the disclosure. The method 300 or at least a portion thereof can be performed by an image signal processor of the digital camera. The method 300 begins in a step 305.

In a step 310, sharpness metrics for a scene are generated. The sharpness metrics can be focus metrics that are used to command a lens, such as the lens 110, to choose an appropriate focal distance to acquire a focus image. The focus metric, therefore, is a statistic used to drive autofocus logic of an autofocus module.

A raw image of the scene is obtained in a step 320. The raw image is obtained after autofocusing. The focused raw image can be stored in a buffer, such as a circular buffer. In a step 330, a command to photograph the scene employing the digital camera is received. After obtaining the focused raw image and receiving the command, a captured image of the scene is selected in a step 340. The captured image is selected employing the sharpness metric, such as the focus metric. The method 300 ends in an end step 350.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

A portion of the above-described apparatuses, systems or methods may be embodied in or performed by various processors, such as conventional digital data processors or computing devices, wherein the processors are programmed or employ stored executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods, or functions of the apparatuses described herein.

Portions of disclosed embodiments may relate to computer storage products with a non-transitory computer-readable medium that have program code thereon for performing various computer-implemented operations that embody a part of an apparatus, system or carry out the steps of a method as set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. An image capturer for reducing the effect of shutter shake of a digital camera in a smartphone, comprising:
a control interface configured to receive a command to photograph a scene; and
a best shot determiner, coupled to said control interface and configured to select, after a focused image of said scene has been acquired and in response to receiving said command, a captured image of said scene based on sharpness metrics.

2. The image capturer as recited in claim 1 wherein said best shot determiner is configured to select said captured image from a buffer of raw images.

3. The image capturer as recited in claim 2 wherein said best shot determiner is further configured to select said captured image based on a propinquity between receiving said command and when said raw images were obtained.

4. The image capturer as recited in claim 2 wherein said buffer is a negative shutter lag buffer of said digital camera and said sharpness metrics are focus metrics employed by said digital camera to acquire said focused image.

5. The image capturer as recited in claim 1 wherein said best shot determiner is configured to select said captured image before full processing of said captured image by an image signal processor of said digital camera.

6. The image capturer as recited in claim 2 wherein said captured image is one of said raw images stored in said buffer having an optimal sharpness metric.

7. The image capturer as recited in claim 1 wherein said best shot determiner is configured to select a raw image, as said captured image, having an optimally evaluated image from said raw images obtained within a designated time of receiving said command.

8. A method of capturing an image employing a digital camera, comprising:
generating sharpness metrics for raw images of a scene;
obtaining a focused image of said scene from said raw images employing said sharpness metrics;
receiving a command to photograph said scene employing said digital camera; and
selecting, after said obtaining and said receiving, a captured image of said scene based on said sharpness metrics.

9. The method as recited in claim 8 wherein said selecting includes selecting said captured image from a buffer of raw images.

10. The method as recited in claim 9 wherein said selecting is further based on a recency of said raw images.

11. The method as recited in claim 9 wherein said sharpness metrics are focus metrics.

12. The method as recited in claim 9 wherein said captured image is one of said raw images and said selecting occurs before full processing of said captured image by an image signal processor of said digital camera.

13. The method as recited in claim 9 wherein said captured image is one of said raw images stored in said buffer having an optimal sharpness metric.

14. The method as recited in claim 8 wherein said generating is performed by an autofocus function of said digital camera.

15. A smartphone, comprising:
a lens for viewing a scene;
a shutter configured to activate a capture command to photograph said scene;
a photodetector configured to acquire multiple raw images of said scene; and
an image signal processor including:
a focus metric module configured to generate focus metrics for said raw images that are employed by said lens to obtain a focused image of said scene from said raw images; and
an image capturer for reducing the effect of shutter shake when employing said shutter, said image capturer having a best shot determiner configured to select, after said focused image has been obtained, a captured image of said scene from a buffer of said raw images based on said focus metrics and in response to said capture command.

16. The smartphone as recited in claim 15 wherein said image signal processor includes an image processing pipeline that includes said focus metric module, said buffer and said image capturer, wherein said image processing pipeline further includes a downscale module placed after said focus metric module.

17. The smartphone as recited in claim 16 wherein said best shot determiner is further configured to select said captured image based on a propinquity between receiving said command and obtaining said raw images.

18. The smartphone as recited in claim 16 wherein said best shot determiner is configured to select said captured image before full processing of said captured image by said image signal processor.

19. The smartphone as recited in claim 15 wherein said best shot determiner is configured to select a raw image having an optimally evaluated image from said raw images obtained within a designated time of receiving said capture command.

20. The smartphone as recited in claim 15 wherein said best shot determine is configured to sort images in a negative shutter lag buffer based on quality and dynamically select one of said sorted images as said captured images.
